(19) United States
(12) Patent Application Publication
(10) Pub. No.: US 2015/0334174 A1
(43) Pub. Date: Nov. 19, 2015

(54) APPLICATION COORDINATION

(71) Applicant: Red Ant Group Limited, Kent (GB)

(72) Inventors: Daniel J. Mortimer, Kent (GB); Daniel J Hartveld, London (GB)

(21) Appl. No.: 14/713,031

(22) Filed: May 15, 2015

Related U.S. Application Data
(60) Provisional application No. 61/994,518, filed on May 16, 2014.

(51) Int. Cl. H04L 29/08; H04L 29/06

(52) U.S. Cl. CPC H04L 67/10; H04L 67/42

(57) ABSTRACT

Disclosed herein is a computer-implemented method for coordinating a plurality of applications operating on a device, each application arranged to communicate with one or more servers for the application and the one or more servers associated with the application to provide one or more functions. The method comprises receiving information indicative of a function required by a first application of the plurality of applications, wherein the required function is not one of the one or more functions provided by the first application and its associated one or more servers. The method further comprises identifying a second application of the plurality of applications that is capable of providing the required function with the one or more servers associated with the second application. The method also comprises initiating communication with the second application for the first application to utilise the required function provided by the second application and the one or more servers associated with the second application.

### FIELD OF INVENTION

This disclosure relates to the coordination of applications on a device. More specifically, but not exclusively, a method is provided for enabling applications on a device to utilise a function that they are not able to directly provide by cooperating with other applications on the device that are able to provide the function.

### BACKGROUND

Software developers are looking to create functionality to fulfil specific tasks for users as part of a much larger system that both provide users with a wide variety of functionality but also to build on the tasks and functions that have been created by other parties to enhance their own software. One way in which this is commonly achieved is by applications, or “apps”, having particular functionalities. FIG. 1 illustrates a system using such apps in which a local client device provides a product information app and a chat app to a user of the local client device. As can be seen from FIG. 1, each app primarily accesses a single server-side dependency or service where it can conduct its primary responsibilities. In the example of the Product Information app this may be a product search API. Any changes made to this product search API will need to be supported by a codebase of the Product Information app.

It is becoming common for each different app to be required to perform actions or show information about areas for which it is not primarily responsible. For example, the Chat app may need to show product information that users are referring to in each message. As shown in FIG. 2, this therefore requires the Chat app to communicate with both sets of web services. Consequently, this means that both apps are dependent on both sets of web services in order to function correctly.

The core difficulty of such growing and entangled software development is that as software becomes more interdependent and more functionality is given to a single system the system as a whole becomes increasingly difficult to change and requires each contributor to understand the system as a whole which often results in inefficient or repeated code and data communication. For example, a minor update to just a single web service will require all apps that access that web service to have their codebase updated. Furthermore, extensive testing to ensure that the minor update does not affect the performance of any of the apps with which it is arranged to communicate will be required. These problems become further exacerbated as more and more apps are added to the system.

### SUMMARY OF INVENTION

A system described herein helps to at least partially solve some of the problems of supporting and modifying highly independent code as well as repetition of data transfer for different areas of a system that offers a wide variety of functionality but uses similar information and business data. The result is a system that is faster, uses less bandwidth and can be modified with less disruption to the system as whole, compared to traditional alternatives.

By separating different tasks or business areas into independent client apps each with their own code base and code libraries it is possible to reduce code dependencies and allow parallel development and deployment

In one arrangement, rather than each app requesting different business data from the servers, apps only show information and user interface elements surrounding the business data for which it has specific responsibility. Each app is also responsible for providing a responsive user interface element for use by other apps. For any other business object it is not responsible for, the app communicates client-side with an app coordinator to get the relevant user interface element that needs to be shown.

In accordance with an aspect of the invention there is provided a computer-implemented method for coordinating a plurality of applications operating on a device, each application arranged to communicate with one or more servers for the application and the one or more servers associated with the application to provide one or more functions. The method may comprise receiving information indicative of a function required by a first application of the plurality of applications. The required function may not be one of the one or more functions provided by the first application and its associated one or more servers. The method may further comprise identifying a second application of the plurality of applications that is capable of providing the required function with the one or more servers associated with the second application. The method may also further comprise initiating communication with the second application for the first application to utilise the required function provided by the second application and the one or more servers associated with the second application.

The received information indicative of the function required by the first application may identify a specific function required by the first application. Alternatively, the information indicative of the function required by the first application may be based on an input by a user of the first application. The information indicative of the function required by the first application may be received at an application coordinator of the device. The identifying may be performed by the application coordinator by utilising a look-up table including information relating to the functionality of each application of the plurality of applications. The application coordinator may compare the information indicative of the function required by the first application with the information relating to the functionality of each application of the plurality of applications stored in the look-up table in order to identify the second application. Prior to identifying the second application, the application coordinator may determine two or more applications capable of providing the required function. The method may further comprise identifying which of the two or more applications capable of providing the required function is to provide the required function. The identifying which of the two or more applications capable of providing the required function is to provide the required function may further comprise identifying a strictness level associated with the information relating to the functionality of each of the two or more applications, wherein the second application is the application with the highest strictness level. If the two or more applications have the same strictness level, the method may further comprise determining which of the two or more applications was registered with the look-up table first, wherein the second application is the application that was first registered with the look-up table. Upon initiation of the application, each application may provide the application coordinator with information relating to the one or more functions it is able to provide and the application coordinator stores the information received from each application in the look-up table. The application coordinator may perform the initiating of the communication. The application coordinator may initiate the communication by requesting at least an aspect of the required function from the second application, upon receiving the at least an aspect of the required function from the second application, the application coordinator provides the at least an aspect of the required function to the first application. The at least an aspect of the required function may be a user interface element arranged to be displayed within the first application. A user of the device may be able to interact with the user interface element, which results in a direct communication from the first application to the one or more servers associated with the second application via the second application. The information indicative of the function required by the first application may be received at the first application. The identifying may be performed by the first application sending a communication to all applications of the plurality of applications requesting that any application capable of performing the required function identifies itself to the first application. The first application may perform the initiating with the second application.

In accordance with another aspect of the invention there is provided a device having a processor for managing the operation of a plurality of applications operating on the device, each application arranged to communicate with one or more remote servers to provide one or more functions. The processor is arranged to perform any method described herein.

In accordance with another aspect of the invention there is provided a computer readable medium comprising computer readable code operable, in use, to instruct a computer system to perform any method described herein.

Each application may be arranged to communicate with the one or more servers over a network.

The computer-implemented method may further comprise updating an application of the plurality of application responsive to a request to update the application.

### BRIEF DESCRIPTION OF THE DRAWINGS

Exemplary embodiments of the invention shall now be described with reference to the drawings in which:

FIG. 1 illustrates a first prior art system in which applications on a device utilise remote web services;

FIG. 2 illustrates a second prior art system in which applications on a device utilise remote web services;

FIG. 3 illustrates an exemplary embodiment of a system in which applications on a device utilise web services;

FIG. 4a provides an example of what is displayed to a user on a user interface when implementing the system illustrated by FIG. 1;

FIG. 4b provides an example of what is displayed to a user on a user interface when implementing the system illustrated by FIG. 3; and

FIG. 5 is a flow diagram of an exemplary process of operation of the system of FIG. 3.

Throughout the description and the drawings, like reference numerals refer to like parts.

### SPECIFIC DESCRIPTION

In the exemplary embodiment of the invention described herein, a client device is provided with functionality that enables multiple apps on the device to utilise information and functions of a wide-range of web services without resulting in an entangled system. Consequently, a system that makes updating functionality of single apps simple and reduces the network bandwidth usage of the client device as a whole is provided without reducing the functionality and effectiveness of the client device. In order to understand how these advantages are achieved, the system arranged to provide such functionality shall firstly be explained in detail.

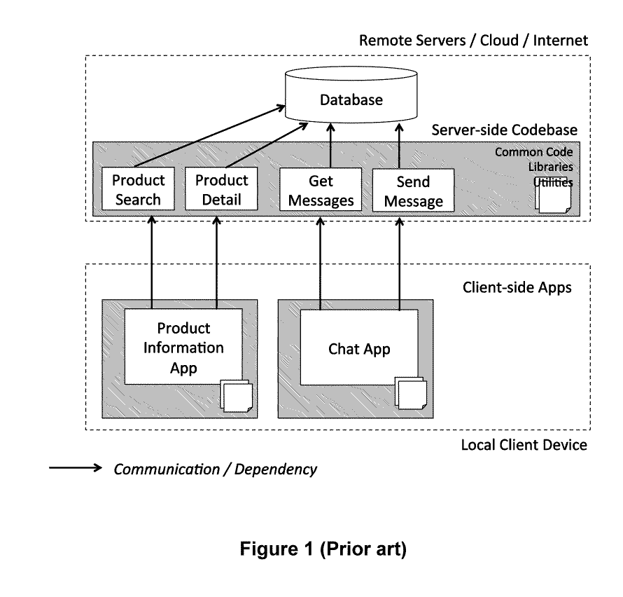

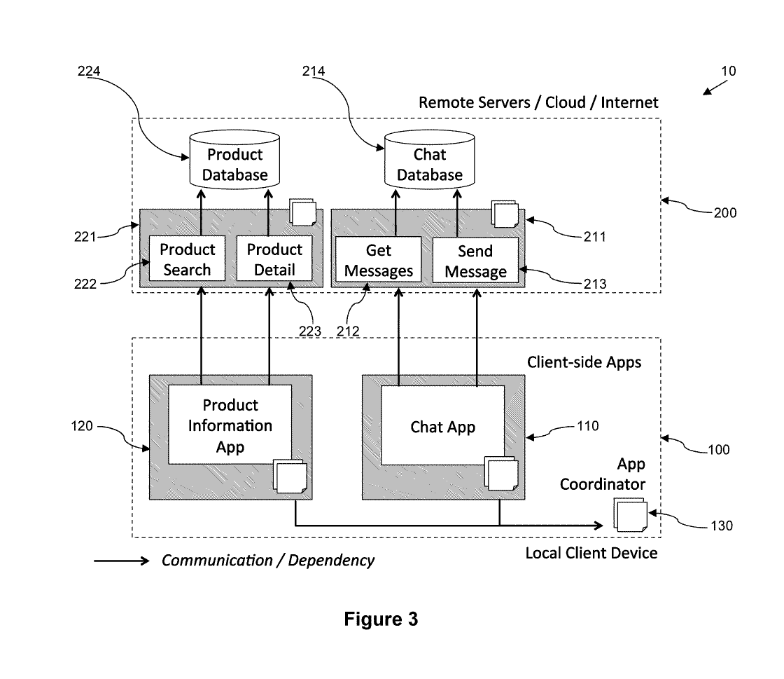

FIG. 3 illustrates an exemplary multi-app environment or system 10 in which a client device 100 having a plurality of apps 110, 120 accesses remote web services 211, 221 associated with each respective app on a remote server 200. The client device 100 may be any electronic device capable of supporting multiple apps such as a smart phone, tablet, or desktop computer. While FIG. 1 illustrates the server 200 as a single server it will be appreciated that the server may be cloud based, or alternatively there may be a separate server associated with each web service 211, 221.

Each app 110, 120 is arranged to directly communicate with its respective web service 211, 221 over a network (not shown). In fact, in this arrangement each app 110, 120 only communicates with its respective web service 211, 221. As can be seen in FIG. 3, chat app 110, which is an online messaging app that allows a user of the client device to chat with other users, communicates with its respective web services 211, which include a ‘get messages’ web service 212 and a ‘send message’ web service 213. In addition, product information app 120, which is able to obtain information relating to a product to be purchased on the client device 100, communicates with its respective web services 221, which include a ‘product search’ web service 222 and a ‘product detail’ web service 223. Each web service is then communicatively coupled to a respective database for accessing further information as and when is required. As can be seen in FIG. 3, ‘Get Messages’ 212 and ‘Send Message’ 213 are in communication with ‘Chat Database’ 214, while ‘Product Search’ 222 and ‘Product Detail’ 223 are in communication with ‘Product Database’ 224. While the databases 214, 224 are shown as being part of server 200, it will be appreciated that one or more of the databases may be hosted by a separate remote server or spread across a cloud environment. These databases store information that is used by each respective web service in order to provide the required web service. For example, ‘Chat Database’ 214 stores messaging information, while ‘Product Database’ 224 stores information relating to products.

FIG. 3 only illustrates the connection between each web service and a single client device. However, it will be appreciated that each web service will provide functionality for a number of client devices. Furthermore, each web service may have other functionalities not shown in FIG. 3. For example, in addition to communicating with the ‘Chat Database’ 214 it will be appreciated that the chat web service 211 is arranged to manage communications between client devices.

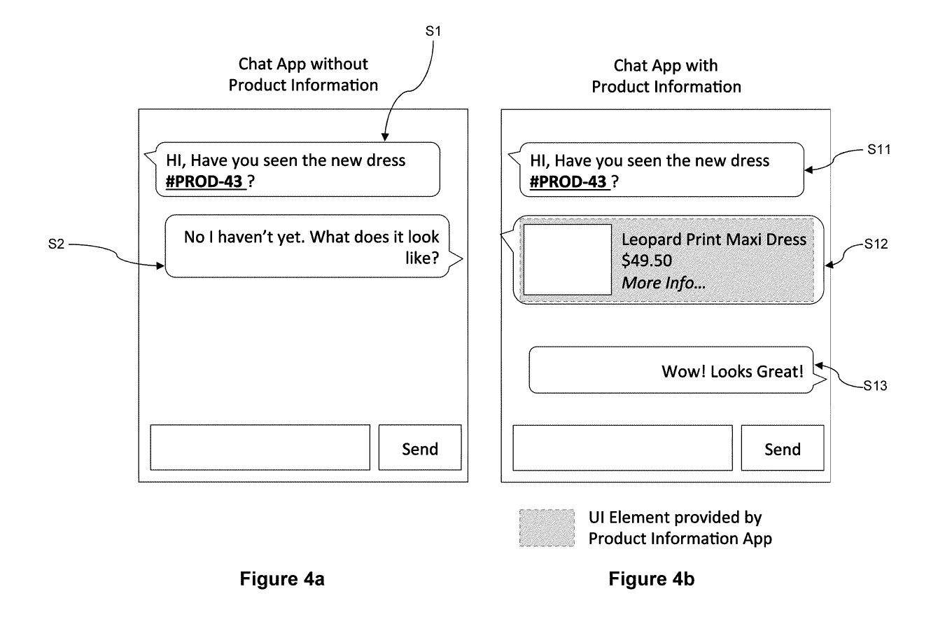

The client device 100 allows for each app 110, 120 to access functionality and web services primarily associated with other apps. FIGS. 4a and 4b provide screen shots of a user interface of the client device 100 as seen by the user and these Figures assist in understanding the need for such functionality, as described below.

Imagine a user of the client device 100 who is shopping using the product information app 120. The user then wants to see what her friend thinks of a dress that she has found on the product information app 120 by sending her friend a message using the chat app 110. FIG. 4a shows the functionality achieved by the prior art system of FIG. 1 wherein apps cannot utilise functionality of other apps. At step s1 the user sends a message to her friend about a dress that she likes, but given that no information relating to the product is sent to her friend, her friend is not able to look at the dress without searching for the dress on the product app on her own client device or asking the user for more information as shown by step s2 in FIG. 4a. FIG. 4b shows the functionality that is achieved by the system of FIG. 3. In FIG. 4b the user asks her friend if she has seen a new dress that she likes at step S11. The system automatically recognises that the user has identified the dress using the product information app and therefore obtains information relating to the dress from the product web service 221, which is sent to her friend at step S12. Consequently, the user's friend is able to respond with her opinion of the dress at step S13.

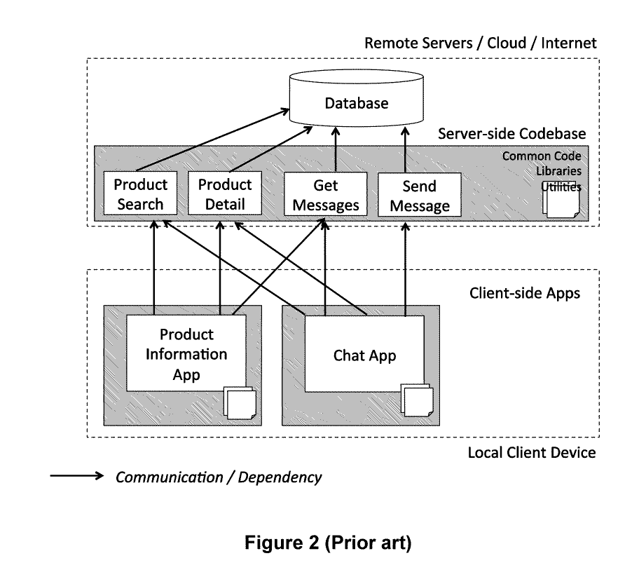

In the prior art system of FIG. 2 this functionality is provided by providing each app with the ability to communicate with all web services with which it may need to communicate. In contrast, in the system of FIG. 3 each app is only provided with the functionality it needs for communicating and using functionality of its respective web service. The app coordinator then provides the functionality that enables apps to utilise functions associated with other web services.

In order to provide the functionality shown in FIG. 4b, where one app utilises functionality associated with another app, each app is able to send a message to the app coordinator 130 requesting certain functionality or information that it would like to provide. For example, in the case of FIG. 4b the chat app 110 sends a message to the app coordinator 130 requesting use of product information functionality. The app coordinator 130 then identifies an app capable of providing such functionality, in this case the product information app 120, and messages the identified app in order to obtain the required information. The required information is then provided by the product information app to the chat app.

Some of the advantages of the system shown by FIG. 3 when compared to that of FIG. 2 are as follows. Since each app only provides functionality directly associated with itself, e.g. the chat app is only capable of providing chat-related functions, and each app is only arranged to communicate with its associated web services, updating each app is a simple and easy process. For example, when the get messages 212 web service is updated, only the chat app 110 need be updated accordingly. This is particularly advantageous when there are a large number of apps on the client device. In contrast, in the system of FIG. 2, when the get messages 212 web service is updated, all apps have to be updated accordingly. This increases data communications across the network, slows down or prevents the use of each app while updating and can cause many other problems for developers who have to ensure that their update does not affect the working of all apps that access the web service. The system of FIG. 3 circumvents at least some of these problems. In addition, as more interoperable apps are added to the client device the overall complexity of the client device does not increase linearly with the system of FIG. 3. Instead, each app works in the same way irrespective of the addition of more and more apps. Furthermore, given that only the app arranged to perform a certain function and communicate with a particular web service provides the certain function and communicates with the particular web service, means that each app can combine communications between itself and its associated web service, which may derive from different apps, to thereby reduce the bandwidth usage associated with the client device. In other words, the system of FIG. 3 allows many apps to each operate with their own areas of responsibility while still having a wide variety of functionality and low levels of dependency.

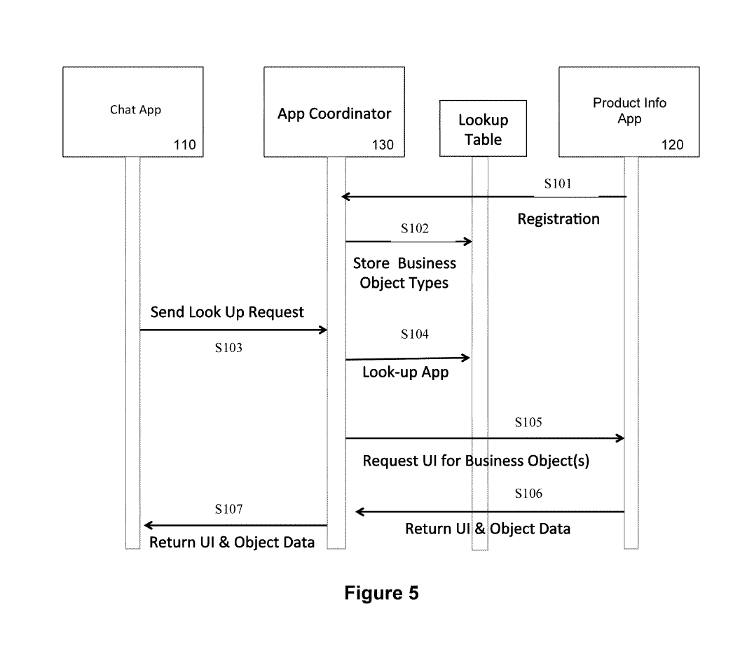

The operation of the system of FIG. 3 for performing the process shown in FIG. 4b shall now be discussed in detail with reference to FIG. 5.

When a new session is started and an app is initialised on the client device 100 it firstly registers itself with the app coordinator 130. Step s101 in FIG. 5 shows the product information app 120 registering with the app coordinator 130 responsive to the user initialising the product information app 120. In this registration process each app sends a registration communication to the app coordinator 130. The registration communication includes the following information for each business object it is responsible for:

Business Object Metadata
The business object metadata defines some fixed fields, such as ID, name, thumbnail, description and optional fields, which include information that other apps might want access to for specific object types, e.g. price, colour, or created-date. The fixed and optional fields can be accessed as part of the object data that will be returned by the app when it is providing information for another app, e.g. the specific product data, such as product names and prices that the product app 120 can provide to the chat app 110 when the chat app makes a request for product information. These fields can then be accessed by other apps within the client device if required to help determine how to display and/or control the user interface (UI). These fields provide functions or functionality that is additional to an apps existing functionality. The app that has requested use of the functionality simply adds a UI element to its UI, but has no knowledge of what this UI element does because the actual functionality is provided by the app that is able to provide the functionality and that has provided the UI element. However, the app requesting certain functionality need not just provide the exact functionality that it is given, instead it can alter the functionality provided. For example, if a function or object is requested, the associated data (e.g. name, price, etc) is returned to the app that is requesting the functionality. The app requesting the function can then alter the functionality based on the information that is received. For example, the chat app might just want to shows a product's thumbnail and not the full product UI element. If this is the case, the chat app would use the data associated with the function that has been returned rather than using the UI element. It will also be appreciated that an app may request that more than one function or object is provided and as such an appropriate number of functions or objects will be returned to that app.

Object User Interface Callback
This is a function reference that can be called with a look-up term and will return the UI element for displaying and interacting with the required business object. The UI element should be responsive to different dimensions and restrictions placed upon it by an app requesting a function. The object user interface callback is therefore the hook into the responding app that the app coordinator calls to get the required UI element back. For example, it would be a function name called ‘getProductUI(ProductCode)’. When the requesting app makes a request to the app coordinator, for a Product UI Element with look-up ABC-123—the app coordinator looks up the app responsible for ‘Product’ and then calls the Object UI Callback that has been registered for that app—getProductUI(ABC-123). This would then return the UI element that the app coordinator passes back to the requesting app.

Object Data Callback
This is a function that will just return the business object data, to allow the app requesting a function to display the information returned in whichever way it requires. The object data callback effectively performs the same functionality as the object user interface callback except that instead of being a function that returns the UI element it is a function that returns the object data (with the fields specified by the Business Object Metadata).

Business Object Look-Up Format (OBLF)
This is a Regular Expression that defines how the look-up term for the relevant business object is defined. It will usually relate to the object's ID format but also can be used to differentiate between different kinds of object. The OBLF is a way of defining the format that the look-up string needs to take. Regular Expressions have a specific syntax for defining a format that is allowed. For example, the product app only takes product codes and so would be [A-Z][A-Z][A-Z]-([0-9]*), which means it must be 3 alphabetical characters, followed by a hyphen, followed by any number of numbers, e.g. ABC-1234. There could then be user app which only accepts user IDs of the form ([A-Z]*).([A-Z]*) which means it must be any number of alphabetical characters followed by a full stop and then any number of alphabetical characters. They can be used to differentiate between the different kinds of objects an app might want, even if the app does not know which type of object is being referred to. For example, if a user using the chat app typed #PRO-1234, the chat app would make a request to the app coordinator accordingly, the app coordinator would find the app that has an OBLF that matches that format (Product App) and then return the Product UI element. However, if the user typed #john.smith, the same request to the app coordinator would find the user app that matches that format and return the User UI element accordingly.

When the app coordinator 130 receives a registration communication it stores the information incorporated within the registration communication into a look-up table associated with the app coordinator 130 at step s102. The look-up table is a database stored in memory. This database may form part of the app coordinator and therefore be stored on the client device. The app coordinator holds the registration information about an app, i.e. the registered metadata, callbacks and look-up format, to allow it to request object information from the right app when requested. Only this information is stored in the look-up table so that there is sufficient information for the app coordinator to identify which app to go to when a request for a certain function comes into the app coordinator. The actual function is then provided to the app requesting the function by the app capable of providing the function.

Each app installed on the client device assumes that only the business objects that the app is responsible for are available. For example, the chat app 110 of FIG. 3 assumes that it only has access to the get messages web service 212 and the send message web service 213. Consequently, each app assumes that it can perform all of its primary tasks without access to any additional business objects that might be available via the app coordinator 130. Furthermore, each app has no knowledge of the user interface required to show or perform actions on business objects for which it is not responsible.

An app on the client device 100 may make a request for either a specific known type of business object, or for an unknown business object type based on some user input. In FIG. 5, the chat app makes a specific request at step s103 for a business object associated with a product referenced in the chat app. Alternatively, if the business object type is unknown a user input such as a hashtag ‘#’ could be used as an indicator for the request.

The following information is therefore sent to the app coordinator 130 by the chat app 110:
Look-up term (e.g. the string ‘ABC-123’),
Business Object (if known),
Data or UI request (a Boolean flag to indicate whether the app just wants the raw object data such as the name, ID, etc, or a full UI element),
User interface constraints (e.g. the maximum width or height that the UI element can be).

When the app coordinator 130 receives the request from the chat app 110 it will then use the received information to identify an app capable of providing the required functionality from the look-up table. If a specific business object is specified then the app coordinator 130 identifies an app on the client device capable of providing the desired functionality from the look-up table as shown by step s104, i.e. an app listing the specific business object. Alternatively, if the business object may not be specified in the request received from the chat app 110 then other information such as the format of the look-up term is used to identify a suitable app. In either case, the app coordinator compares the string identifying the required function with strings stored in the look-up table and identifies apps having matching strings. If the app coordinator 130 identifies more than 1 app that fulfils the criteria of the request then the app with the strictest OBLF, i.e. having a format for which the least number of values would fit, is used. If both apps have the same level of strictness in their OBLF then the first app registered on the client device is used. For example, if a News Search App has an OBLF that is any alphabetical string, and a Product Info App has an OBLF that is of the format XX-XXX. The look-up term of AB-CDE would result in the Product Info App being selected.

At step s105, the app coordinator, having identified that the product info app 120 is capable of providing the required functionality, will call the UI Callback in the product info app's 120 code and environment with the info that is required from it and wait for the UI element or object data to be returned.

If the required UI element is successfully returned at step s106, it will be sent to the chat app 110 by the app coordinator 130. It will then be up to the chat app 110 to determine where in its user interface this element will be displayed.

Once the UI element is displayed by the chat app 110 the user of the client device 100 can interact with this UI element, and from a functional perspective of the user the UI element will act as if the user is interacting within the chat app's 211 environment. Certain actions may even trigger the product information app 120 to take focus, i.e. display the UI of the product information app 120.

The process of FIG. 5 therefore shows how the system of FIG. 3 allows individual apps to show functions and/or UI elements that lie without its core functionality without any knowledge of the business and functional area to which the functions and/or UI elements correspond. Consequently, the caching and communication control with the server for each business object or app is controlled by a single point, i.e. by a single app.

In an alternative arrangement, the app coordinator and the look-up table are not required. Instead, a first app sends a communication out to all other apps installed on the client device requesting that any apps capable of performing a required function identify themselves to the first app. The first app then initialises communications with an app that identifies itself as being able to provide the desired functionality to the first app over a network. Consequently, the first app is able to provide functionality that it is not directly able to provide via another app that is arranged to provide such functionality.

The various methods described above may be implemented by a computer program. The computer program may include computer code arranged to instruct a computer to perform the functions of one or more of the various methods described above. The computer program and/or the code for performing such methods may be provided to an apparatus, such as a computer, on a computer readable medium or computer program product. The computer readable may be a transitory or a non-transitory computer readable medium. For example, the computer readable medium could be an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

An apparatus such as a computer may be configured in accordance with such code to perform one or more processes in accordance with the various methods discussed herein. Such an apparatus may take the form of a data processing system. Such a data processing system may be a distributed system. For example, such a data processing system may be distributed across a network.

The client device may comprise a processor and a memory coupled to the processor. The processor arranged to perform the method associated with the functions provided on the client device such as that of those apps stored on the client device and the app coordinator. The look-up table may be part of the memory on the client device. Alternatively, the client device may use external memory for storage of the look-up table.

1. A computer-implemented method for coordinating a plurality of applications operating on a device, each application arranged to communicate with one or more servers for the application and the one or more servers associated with the application to provide one or more functions, the method comprising:
receiving information indicative of a function required by a first application of the plurality of applications, wherein the required function is not one of the one or more functions provided by the first application and its associated one or more servers;
identifying a second application of the plurality of applications that is capable of providing the required function with the one or more servers associated with the second application; and
initiating communication with the second application for the first application to utilise the required function provided by the second application and the one or more servers associated with the second application.

2. The computer-implemented method of claim 1, wherein the received information indicative of the function required by the first application identifies a specific function required by the first application.

3. The computer-implemented method of claim 1, wherein the information indicative of the function required by the first application is based on an input by a user of the first application.

4. The computer-implemented method of claim 1, 2 or 3, wherein the information indicative of the function required by the first application is received at an application coordinator of the device.

5. The computer-implemented method of claim 4, wherein the identifying is performed by the application coordinator by utilising a look-up table including information relating to the functionality of each application of the plurality of applications.

6. The computer-implemented method of claim 5, wherein the application coordinator compares the information indicative of the function required by the first application with the information relating to the functionality of each application of the plurality of applications stored in the look-up table in order to identify the second application.

7. The computer-implemented method of claim 4, 5 or 6, wherein, prior to identifying the second application, the application coordinator determines two or more applications capable of providing the required function and the method further comprises identifying which of the two or more applications capable of providing the required function is to provide the required function.

8. The computer-implemented method of claim 7, wherein the identifying which of the two or more applications capable of providing the required function is to provide the required function further comprises identifying a strictness level associated with the information relating to the functionality of each of the two or more applications, wherein the second application is the application with the highest strictness level.

9. The computer-implemented method of claim 8, wherein if the two or more applications have the same strictness level, the method further comprises determining which of the two or more applications was registered with the look-up table first, wherein the second application is the application that was first registered with the look-up table.

10. The computer-implemented method of any one of claims 5 to 9, wherein, upon initiation of the application, each application provides the application coordinator with information relating to the one or more functions it is able to provide and the application coordinator stores the information received from each application in the look-up table.

11. The computer-implemented method of any one of claims 4 to 10, wherein the application coordinator performs the initiating of the communication.

12. The computer-implemented method of claim 11, wherein the application coordinator initiates the communication by requesting at least an aspect of the required function from the second application, upon receiving the at least an aspect of the required function from the second application, the application coordinator provides the at least an aspect of the required function to the first application.

13. The computer-implemented method of claim 12, wherein the at least an aspect of the required function is a user interface element arranged to be displayed within the first application.

14. The computer-implemented method of claim 13, wherein a user of the device is able to interact with the user interface element, which results in a direct communication from the first application to the one or more servers associated with the second application via the second application.

15. The computer-implemented method of claim 1, 2 or 3, wherein
the information indicative of the function required by the first application is received at the first application;
the identifying is performed by the first application sending a communication to all applications of the plurality of applications requesting that any application capable of performing the required function identifies itself to the first application; and
the first application performs the initiating with the second application.

16. A device having a processor for managing the operation of a plurality of applications operating on the device, each application arranged to communicate with one or more remote servers to provide one or more functions, wherein the processor is arranged to perform the method of any preceding claim.

17. A computer readable medium comprising computer readable code operable, in use, to instruct a computer system to perform the computer-implemented method of any one of claims 1 to 15.
